(19) United States
(12) Patent Application Publication
(10) Pub. No.: US 2004/0090625 A1
(43) Pub. Date: May 13, 2004

(54) Device and method for particle agglomeration

(76) Inventors: Ulrich Fischer, Neuss (DE); Otto Schroers, Krefeld (DE); Benno Wessely, Dresden (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,686

(22) PCT Filed: Sep. 5, 2001
(86) PCT No.: PCT/EP01/10230

(30) Foreign Application Priority Data
Sep. 6, 2000 (DE) 100441564

(51) Int. Cl. G01N 15/02

(52) U.S. Cl. 356/336

(57) ABSTRACT

The invention relates to a device for particle agglomeration, comprising a supply line carrying a fluid with a particle load, and a probe which is connected to the supply line. Data related to a parameter PT which is dominated by the particle size, and to a parameter PK which is dominated by the concentration of the particle load in the fluid, can be determined by means of said probe, via a measuring signal. The invention also relates to a method for controlling the agglomeration of particles and to the use of the inventive device or method for treating waste water.

The invention relates to a device for particle agglomeration, a method of controlling the agglomeration of particles, as well as to the use of said device and/or method in the treatment of process water, preferably waste water.

To date, there is no satisfactory way of continuously measuring a particle load in a fluid. Continuous measurement, also referred to as online measurement, is of high significance in the separation of fluid and particle load by means of an agglomerating agent, because online measurement of the particle load allows for precise metering and selection of the particle agglomerating agent. In particular, such problems arise during the work-up of fluids including a particle load, which fluids result from fermentation processes, from the recovery of raw materials, preferably coal and aluminum, from paper manufacturing, and from the sugar industry. In this context, the treatment of sewage sludge should be mentioned, in particular.

In the course of the above-mentioned work-ups, fluid samples are taken, and the concentration of the particle load in the fluid and the particle size or particle size distribution in the fluid are determined in a laboratory. As to the concentration, this is done by drying and weighing the sample. The particle size or particle size distribution is determined by screening, or by means of microscopic investigations, and by recording and evaluating laser diffraction spectra.

These methods only permit indirect and time-shifted determination of the particle load and particle size or particle size distribution.

Such a time-delayed determination is disadvantageous in that responding to changes in the particle load as promptly as possible cannot be achieved. This leads to fluctuations in the particle agglomerate and imprecise use of the agglomerating agent, frequently resulting in excessive metering thereof.

Furthermore, the previous measuring methods are cost-intensive because their realization is only possible with considerable input of personnel and time.

EP 0,819,022 discloses a process and a plant for online measurement, wherein the density and the volume per time are considered in the conditioning and dewatering of a suspension.

The process and plant in this disclosure suffer from the fact that precise metering and/or selection of the agglomerating agent or conditioning agent are effected without considering the particle size and the particle size distribution resulting therefrom.

In F&S Filtrieren und Separieren, Vol. 13 (1999), No. 5, pp. 209-216, the kinetics of kaolin particle flocculation in a stirred vessel is determined by extinction measurements.

This document neither teaches a method for the precise metering and/or selection of a suitable flocculant, because metering and selection cannot be deduced from the kinetics in a straightforward manner.

Generally, the object of the invention is to overcome the above-mentioned drawbacks known from the prior art.

Another object of the invention is to ensure metering of agglomerating agents as precisely as possible.

Furthermore, it is an object of the invention to select an agglomerating agent or a combination of agglomerating agents which preferably would be suitable for agglomerating a particle load.

Moreover, it is an object of the invention to be capable of responding as promptly as possible to fluctuations in the particle load and/or changes in the particle properties in a fluid. In particular, this applies to particles from fermentation processes, such as sewage sludges of municipal and/or industrial sewage plants, which particles are compressible particles defying precise definition.

In addition, it is an object of the invention to produce an agglomerate as homogeneous as possible in its properties over time.

The objects of the invention are accomplished by means of a device according to claim 1, a method according to claim 12, and their use according to claim 18.

The above objects are accomplished by means of a device including a supply line which carries a fluid with a particle load, a probe connected to the supply line, said probe generating a measuring signal, preferably via light scattering, ultrasound, extinction, or Coriolis force, or via at least two thereof, with light scattering being particularly preferred, allowing for the determination of values for a parameter PT dominated by the particle size and a parameter PK dominated by the concentration of the particle load in the fluid. A bypass arrangement of the probe in a branched supply line is preferred.

In a preferred embodiment of the device according to the invention, the measuring signal is exclusively detectable by measuring the backscattering of light rather than the extinction, i.e., a spectral measure of absorbance or a decimal absorbency.

Preferably, the fluid including a particle load is a fluid derived from a fermentation process, with processes taking place in digestion towers of sewage plants being particularly preferred as fermentation processes. According to the invention, particularly preferred fluids including a particle load are sewage sludges.

According to another embodiment of the invention, the fluid including a particle load comes from paper manufacturing. In addition to the waste waters from paper manufacturing, the pulps obtained in association with paper manufacturing should also be mentioned. Particularly preferred are fluids that are applied on the screen section of the papermaking machine. These fluids preferably include paper fibers and fillers in amounts ranging from 0.01 to 10 wt.-%, relative to the fluid.

Another embodiment of the invention relates to a fluid containing residues from the food production as particle load, which residues preferably are obtained in slaughterhouses or in the sugar production.

Another embodiment of the invention relates to a fluid containing residues from coal mining as particle load, preferably from coal washing.

Another embodiment of the invention relates to a fluid which is obtained in bauxite processing in the course of aluminum production. Preferred in this case are red sludge removal and crystallization of aluminum hydroxide during white operation.

The fluid preferably includes a particle load in an amount ranging from 0.01 to 40 wt.-%, preferably from 0.05 to 10 wt.-%, and more preferably from of 0.1 to 8.0 wt.-%, relative to the fluid.

Particularly preferred according to the invention are fluids including a particle load of least 10, preferably at least 30, and more preferably at least 35 wt.-% of organic particles, preferably particles arising from organisms, corresponding to a loss on ignition of at least 35 wt.-%.

The measuring signal is preferably voltage-modulated. In a particularly preferred fashion, one single measuring signal is required for both parameters PT and PK.

Parameters dominated by the particle size are parameters derived from a change in the measured signal which is predominantly proportional to the particle size. According to the invention, a parameter PK dominated by the concentration is preferably generated from a change in the measured signal which is predominantly proportional to the concentration.

According to the invention, it is preferred that the value of PT can be determined via the standard deviation of the measured signal and the value of PK via the intensity (level) of the measured signal.

The probe used in the device of the invention preferably includes a light source, an optical system, a diaphragm, and a light signal transducer. The light source emits a beam, preferably within the range of visible light, and preferably in a range of from 500 to 700, more preferably in a range of from 550 to 650 nm. It is also preferred that this beam be monochromatic, e.g. one that can be obtained by means of a laser, in particular.

The beam emitted from the light source is passed through the optical system preferably designed in such a way that the beam exhibits a focus in that area where it penetrates the fluid including a particle load.

At least part of the light scattered by the particle load is taken up by a light signal transducer and transformed into a measuring signal. Any light signal transducer known to those skilled in the art and found suitable can be used, with photomultipliers and photodiodes being preferred, and photodiodes being particularly preferred.

Measurement is effected continuously or periodically, e.g. at time intervals. Furthermore, measurement is effected directly on the resulting sludge or following dilution of the sludge with a suitable liquid, preferably water, or with the liquid, preferably aqueous sludge phase free of solids.

In the device according to the invention, it is also preferred that the probe is followed by a separating device, either immediately or by interposing other elements of the device. Any separating device known to those skilled in the art and suitable in the separation of fluid and particle load can be used. Preferred are plate filters, especially chamber and membrane filter presses, screen belt filters and centrifuges, with centrifuges being particularly preferred.

For example, probes usable according to the invention are the “Inline Particle Sensors” of the Aello series as offered in www.aello.de by the GWT der TU Dresden mbH at the time of filing, the Aello 1000 probe being preferred, and the Aello 1000 probe with no extinction being particularly preferred.

Furthermore, an inventive device is preferred wherein a metering means for a particle agglomerating agent is arranged upstream of the probe, or between the probe and separating device, or inside the separating device, or in at least two of the above-mentioned positions. Such a metering means preferably is a reservoir with a controllable valve. It is also preferred that the metering means additionally includes a mixing device allowing distribution of the (particle) agglomerating agent in the fluid as uniformly as possible. Preferably, the metering means, especially the valve of the metering means, can be controlled via the probe in the device of the invention. Thus, if the concentration of particles in the particle load of the fluid decreases, for example, one must be capable of reducing the amount of particle agglomerating agents so as to achieve constant results of agglomeration. If the particle size in the particle load in the fluid increases, for example, a similar reduction in the amount of particle agglomerating agent is necessary to achieve the same agglomeration result.

In another embodiment, a device according to the invention has at least one additional metering means, and said at least one additional metering means allows metering of an agglomerating agent other than that in the first metering means. By combining various (particle) agglomerating agents, it is possible to adjust mixtures of agglomerating agents on the particle load to be treated, depending on the desired result of agglomeration/precipitation.

Preferably, the agglomerating agent(s) is (are) metered into the fluid in amounts ranging from 0.01 to 15 wt.-%, preferably from 0.1 to 10 wt.-%, and more preferably from 0.5 to 5 wt.-%, relative to the particle load.

One group of agglomerating agents that is preferred according to the invention are inorganic coagulating agents such as iron salts and/or aluminum salts such as alum, or other polyvalent inorganic coagulating agents.

In a particularly preferred fashion, the device of the invention allows metering of a polymer flocculation agent (aid) as agglomerating agent via the metering means. Preferably, the polymer flocculation agent (aid) exhibits an intrinsic viscosity ranging from 0.1 to 10 dl/g (measured at 25° C. on a 1N NaCl solution buffered at a pH of 7.5, using a “Suspended Level Viscosimeter”) and optionally, a cationic charge of at least 4 meg/g, or preferably both. Furthermore, it is preferred that the polymer flocculation agent (aid) is dispersible in water, preferably soluble in water.

Predominantly, water-soluble and/or at least water-swellable, partially cross-linked polymers, co- and terpolymers of water-soluble, non-ionogenic and/or ionic monomers and comonomers are used as polymer flocculation agents (aids) in the form of a powder, as an aqueous solution, as a water-in-water dispersion, or as a water-in-oil dispersion. Such polymers are homo-, co- and terpolymers of monoethylenically unsaturated monomers having acid groups present at least in part as salts, or their esters with di-C₁₋₂-alkylamino-C₂₋₆-,-alkyl-alcohols or their amides with di-C₁₋₂-alkylamino-C₂₋₆-alkylamines present in protonated or quaternized form, such as described e.g. in EP-A 113,038 and EP-A 13,416, and optionally other monoethylenically unsaturated monomers.

Preferably, homo- and/or copolymers of monoethylenically unsaturated carboxylic acids and sulfonic acids, such as acrylic acid, methacrylic acid, maleic acid, itaconic acid, crotonic acid, and/or their alkali salts, preferably sodium, potassium or ammonium salts, vinylsulfonic acid, acrylamido- and methacrylamidoalkylsulfonic acids such as 2-acrylamido-2-methylpropanesulfonic acid, 2-sulfoethyl methacrylate and styrenesulfonic acid and/or their alkali salts, preferably sodium, potassium or ammonium salts are suitable as anionic polyelectrolytes, and also, vinylphosphonic acid and styrenephosphonic acid, as well as their alkali salts, preferably sodium, potassium or ammonium salts.

Preferably, cationically active flocculation agents (aids), e.g. homo- and/or copolymers and/or terpolymers of water-soluble, monoethylenically unsaturated vinyl compounds, such as acrylic esters and methacrylic esters of dialkylamino-alkylalcohols in protonated or quaternized form, such as dimethylaminoethyl acrylate, acrylic amides and methacrylic amides of dialkylaminoalkylamines in protonated or quaternized form, such as acrylamidopropyltrimethylammonium chloride and/or acrylamidopropyltrimethylammonium methylmethosulfate are employed, preferably together with acrylamide. Copolymers which can be used according to the invention are also described in EP-B-228,637.

The copolymers can be formed of the above-mentioned ionic monomers and non-ionogenic, water-soluble, monoethylenically unsaturated monomers, such as acrylamide, methacrylamide, N-C₁₋₂-alkylated (meth)acrylamides, and also with N-vinylamide, vinylformamide, N-vinylacetamide, N-vinyl-N-methylacet-amide, N-vinylpyrrolidone. In addition, suitable water-soluble monomers are N-methylolacrylamide, N-methylolmethacrylamide, as well as N-methylol(meth)acrylamides partially or completely etherified with monohydric C₁₋₄ alcohols, and diallyldimethylammonium chloride.

Likewise, the copolymers may include limited amounts of ethylenically unsaturated monomers sparingly soluble and/or insoluble in water, such as (meth)acrylic alkyl esters and vinyl acetate, as long as the solubility or swell-ability of the copolymers in water is retained.

In addition, the polymers can be produced using crosslinking, at least bi-reactive monomers, preferably diethylenically unsaturated monomers, so as to have swellability in water or limited solubility therein, or, they may be comprised of water-soluble and water-swellable polymers.

According to the invention, water-soluble or water-swellable amphiphilic copolymers formed of cationic and anionic monomers and optionally non-ionogenic monomers may also be employed.

In the device of the invention, the supply line carrying the fluid with the particle load is preferably connected to a fermentation reactor, e.g. a digestion reactor. In particular, digestion reactors are digestion towers of sewage plants, wherein sewage sludges of sewage plants are processed, which plants perform waste water treatment by means of fermentation processes.

The invention also relates to a method of controlling the agglomeration of particles in a fluid with a particle load using a particle agglomerating agent, wherein the particle load of the fluid is determined by means of a device of the invention, thereby establishing type and/or amount of the particle agglomerating agent that is metered into the fluid including the particle load.

Moreover, the invention relates to a method of generating an agglomerate of particles, wherein particles in a fluid with a particle load are contacted with a particle agglomerating agent, and the particle load of the fluid, specifically characterized by the solids parameters PK and PT, is determined using a device according to the invention, and, depending thereon, type and/or amount of the particle agglomerating agent metered into the fluid with the particle load are established.

Said contacting is effected using a mixing means, particularly in those cases where the separating device is not a centrifuge. Where a centrifuge is used as separating device, contacting preferably is effected in the centrifuge.

In the method according to the invention, metering as to type and amount of agglomerating agent is established by a deviation of at least one PT value and at least one PK value from at least one predetermined value PTᵥ and one predetermined value PKᵥ, respectively. In this context, it is advantageous to start not only with one, but with several, preferably at least 5, more preferably at least 50 values of PT, PK and PTᵥ and PKᵥ, respectively. One way of predetermining the PTᵥ and PKᵥ values is to perform a calibration measurement according to the conventional method, or to establish the correlation between agglomerate properties and amount of employed agglomerating agent in a test run. Further calibration is obtained e.g. when admixing particles having known size or size distribution. In this way, the process is optimized on the whole, both with respect to agglomeration of the particle load and addition of (particle) agglomerating agent(s) according to type and amount.

In the method according to the invention, the separating device preferably separates the particle agglomerate from at least part of the fluid, preferably water or an aqueous solution, to form a residue. Depending on the intended use of the residue formed, it has to be more or less free of fluid or water. For example, if the residue is to be incinerated in a garbage incineration plant, the residue should be as dry as possible. On the other hand, when applying the residue as soil conditioner on agricultural areas, the residue advantageously can be pumped and sprayed in a suitable fashion. In such a use, it is preferred that only part of the fluid or water is removed from the residue. The invention will now be illustrated in more detail with reference to non-limiting examples and figures.

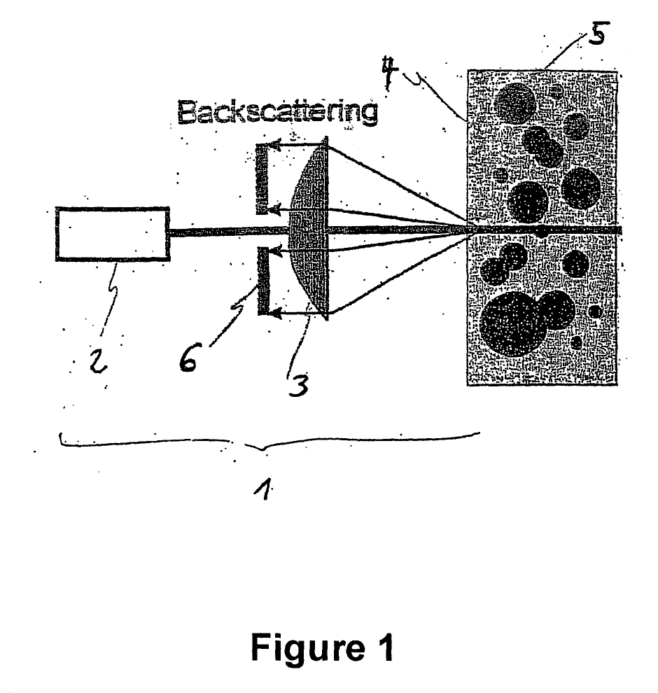

FIG. 1 shows the schematic design of the device according to the invention.

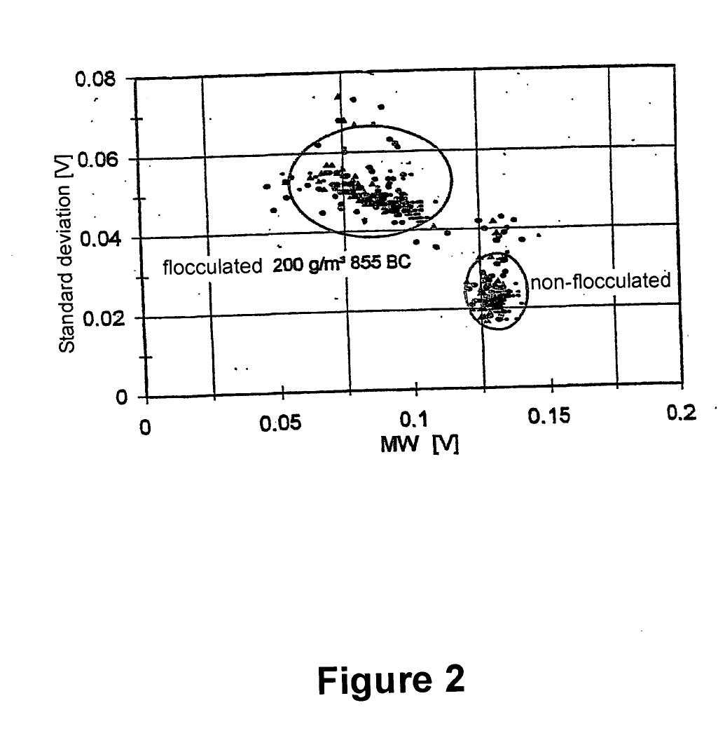

FIG. 2 shows a diagram including the measuring results when performing the method according to the invention.

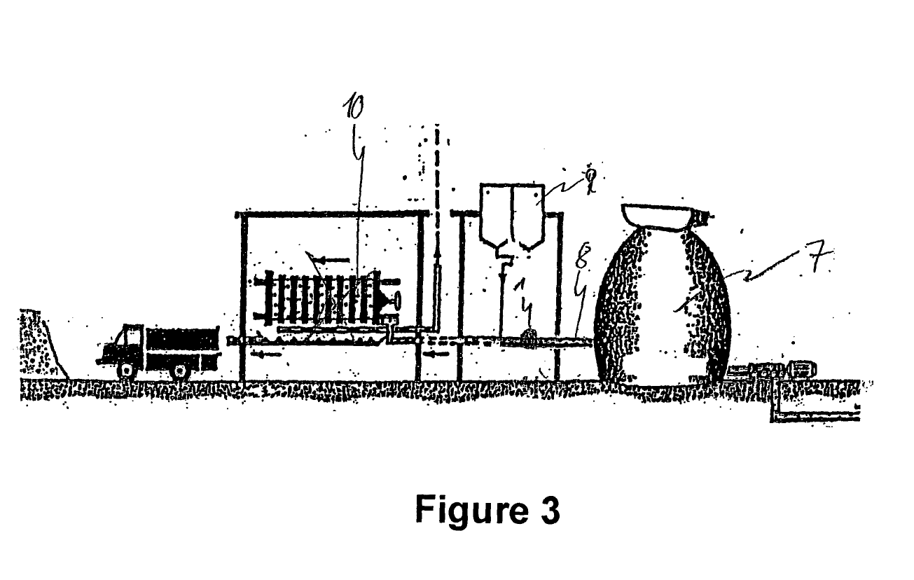

FIG. 3 shows a detail of a sewage plant including a device of the invention.

The probe 1 shown in FIG. 1 is comprised of a light source 2 which directs a light beam through the optical system 3 and into the fluid 4 including the particles 5, said light beam being at least partially scattered by the particles 5 and reflected onto the light signal transducers 6. The light signal transducers 6 transform the incident light into a signal which is processed in a computer unit into a signal whose standard deviation and intensity (level) can be determined.

FIG. 2 shows a diagram wherein the standard deviation of the signal measured with probe 1 is plotted on one axis and the intensity (level) of the measured signal in the form of a voltage on the other. The signals are determined by probe 1 at time intervals which are small compared to e.g. the flow rate of the fluid passing through the beam. The sets of signals obtained in this way form the clusters in the diagram according to FIG. 2 which are characterized by a multitude of measuring points. These clusters are surrounded by cluster boundaries (oval circles). When the central core of the measured points moves outside the cluster, metering of the particle agglomerating agent has to be adjusted. The cluster characterized by the large oval circle represents measured values resulting from flocculated particles of sewage sludge from a municipal sewage plant. The small oval circle surrounds the cluster resulting from non-flocculated particles of sewage sludge from a municipal sewage plant.

FIG. 3 shows a digestion tower 7 having a supply line 8 connected thereto wherein the probe 1 is arranged upstream of the inflow from metering means 9 and which leads to the separating device 10.

Key to the Drawing

1. Probe

2. Light source

3. Optical system

4. Fluid

5. Particles

6. Light signal transducer

7. Digestion tower

8. Supply line

9. Metering means

10. Separating device

1. A device for particle agglomeration, having a supply line which carries a fluid with a particle load and a probe connected to the supply line, which probe generates a measuring signal via light scattering and/or extinction and has a light source, an optical system, an optional diaphragm, and a light signal transducer, characterized in that the probe generates a measuring signal for a parameter PK dominated by the concentration and a parameter PT dominated by the particle size, said PK being determinable from the intensity of the measuring signal and said PT from the standard deviation of the measuring signal.

2. The device according to claim 1, characterized in that the measuring signal is generated via light scattering, preferably via backscattering of the light.

3. The device according to claims 1 to 3, characterized in that the probe is arranged in a bypass arrangement on the supply line carrying the fluid.

4. The device according to any of the preceding claims, wherein the probe is followed by a separating device, either immediately or by interposing other elements of the device.

5. The device according to any of the preceding claims, characterized in that a metering means for a particle agglomerating agent is arranged upstream of the probe, or between the probe and separating device, or inside the separating device, or in at least two of the above-mentioned positions.

6. The device according to claim 5, characterized in that the metering means can be controlled via the probe.

7. The device according to claim 5 or 6, characterized in that the device has at least one additional metering means.

8. The device according to claim 7, characterized in that at least one additional metering means allows metering of an agglomerating agent other than the agglomerating agent in the first metering means.

9. The device according to any of claims 5 to 8, characterized in that at least one polymer flocculation agent (aid) can be metered as particle agglomerating agent via said one or additional metering means.

10. The device according to any of the preceding claims, characterized in that the supply line carrying the fluid with the particle load is connected to a fermentation reactor.

11. The device according to claim 10, characterized in that the fermentation reactor preferably is a digestion tower and the particle load preferably is sewage sludge.

12. A method of controlling the agglomeration of particles in a fluid with a particle load using a particle agglomerating agent, characterized in that the particle load in the fluid, specifically characterized by the solids parameters PK and PT, is determined by means of a device according to any of claims 1 to 11, and, depending thereon, type and/or amount of the particle agglomerating agent metered into the fluid with the particle load are established.

13. The method according to claim 12, characterized in that the metered amount is established by a deviation of at least one PT value and at least one PK value from at least one predetermined value of PTᵥ and at least one predetermined value of PKᵥ, respectively.

14. The method according to claims 12 to 13, characterized in that measurement of the values PT and PK preferably is effected using a bypass arrangement of the probe on the supply line carrying the fluid.

15. The method according to claims 12 to 14, characterized in that measurement is effected continuously or at intervals.

16. The method according to claims 12 to 15, characterized in that measurement is effected directly on the resulting sludge, or preferably following dilution of the sludge with a suitable liquid, preferably water, or on the liquid aqueous sludge phase free of solids.

17. The method according to claims 12 to 16, characterized in that the particle agglomerate in the separating device is separated from at least part of the fluid to form a residue.

18. Use of a device according to any claims 1 to 11 and/or of a method according to any claims 12 to 17 for the treatment of waste water in a sewage plant.
